(19) United States
(12) Patent Application Publication
(10) Pub. No.: US 2024/0379115 A1
(43) Pub. Date: Nov. 14, 2024

(54) DETECTION AND ATTENUATION OF VOCAL ARTIFACTS IN AUDIO

(71) Applicant: Shure Acquisition Holdings, Inc., Niles, IL (US)

(72) Inventors: Stefan Hopman, Evanston, IL (US); Ross Penniman, Morton Grove, IL (US); Justin Sconza, Chicago, IL (US)

(21) Appl. No.: 18/654,624

(22) Filed: May 3, 2024

Related U.S. Application Data
(60) Provisional application No. 63/465,620, filed on May 11, 2023.

(51) Int. Cl. G10L 21/0232; G10L 21/0264

(52) U.S. Cl. CPC G10L 21/0232; G10L 21/0264

(57) ABSTRACT

Automatic detection and attenuation of vocal artifacts in an audio are described herein. First and second amplitude measurements may be generated for respective first and second frequency bands of an audio signal. A vocal artifact indication may be generated based on a ratio of the first and second amplitude measurements. The vocal artifact indication may be used to attenuate at least one of the first frequency band or the second frequency band. An attenuated signal may be provided in which one or more vocal artifacts have been attenuated.

### CROSS-REFERENCE TO RELATED APPLICATION

This application claims priority to U.S. Provisional Patent Application No. 63/465,620, filed on May 11, 2023, which is hereby incorporated by reference in its entirety.

### FIELD

Aspects described herein generally relate to audio signal processing, and/or hardware and/or software related thereto. More specifically, one or more aspects described herein provide for the detection of a one or more vocal artifacts in an audio signal and the attenuation thereof.

### BACKGROUND

Vocal artifacts may include any unwanted noises associated with speech or singing that may get picked up by a microphone. Some examples of a vocal artifact include plosives, sibilance and proximity effect. These artifacts may simply be a property of the voice or may stem from the interaction between the voice and the microphone.

“Pop” (or plosive) is the term generally used to describe the sound that emanates from a loudspeaker that is reproducing a human voice saying words emphasizing strong consonant sounds such as “p,” “t,” “b” and the like. In normal unamplified speech these sounds would not be heard due to the inaudibility of the pop disturbance. However, such a disturbance may cause a microphone diaphragm to move or a grille structure to generate a turbulent acoustic signal. As a result, an unwanted electrical output may be generated by a microphone.

In some examples, a plosive may be characterized by a fast burst of low frequency energy that is primarily below 300 Hertz. A plosive may have an envelope that can be separated into two stages. The first stage may have a quick increase in the low frequency energy that reaches a maximum magnitude. Then, a steady but fast decay of the low frequencies may occur until the energy is comparable to frequency content primarily above 300 Hz. Plosives that occur in a live or recorded microphone signal may often be distracting and may degrade the quality of the live or recorded microphone signal.

Sibilance, or “ess” sounds, occupy the upper frequency range (typically above 3 kHz) of a speech signal. For certain voices and/or talkers and certain vocal sounds, sibilance can be loud and distracting. It can be harsh and fatiguing on the listener's ears.

Proximity effect, may, in some examples, generally describe the increase in low frequencies (below 200 Hz) of a speech signal when a talker and/or singer is very close to a microphone (as compared to further away). The effect may generally be observed on directional microphones (such as those with a cardioid polar pattern). The greater the directionality of the microphone, the more pronounced the proximity effect may be.

### SUMMARY

The following presents a simplified summary of the disclosure in order to provide a basic understanding of some aspects of the disclosure. This summary is not an extensive overview of the disclosure. It is not intended to identify key or critical elements of the invention or to delineate the scope of the invention. The following summary merely presents some concepts of the disclosure in a simplified form as a prelude to the more detailed description provided below.

In many instances, podcasters, broadcasters, audio streamers, recording artists, sound engineers, and the like may wish to minimize the number and severity of artifacts such as pops. It may be difficult to employ certain methods to combat plosives without a working knowledge of various audio techniques. Additionally, a user might not have sufficient time and/or equipment to properly configure audio processing settings to eliminate pop artifacts.

As described in more detail herein, this application sets forth apparatuses, methods, and algorithms for automatically detecting artifacts such as plosives in an audio signal and automatically attenuating the portion(s), or frame(s), of the audio signal that contains the plosive(s). These apparatuses, methods, and algorithms may be helpful in enabling a user to eliminate pop artifacts from an audio signal during a live stream, broadcast, podcast, studio session, and/or live performance.

An example apparatus may comprise a plurality of envelope followers, wherein the plurality of envelope followers may comprise a first envelope follower configured with a first time constant, or first time resolution, to generate, from an audio signal, a first amplitude measurement for a first frequency band of the audio signal and a second envelope follower configured with a second time constant, or second time resolution, to generate, from the audio signal, a second amplitude measurement for a second frequency band of the audio signal. The example apparatus may also comprise a comparator configured to: determine a first amplitude ratio between the first amplitude measurement for the first frequency band of the audio signal and the second amplitude measurement for the second frequency band of the audio signal; and generate, based on the first amplitude ratio, a first vocal artifact (e.g., plosive) indication.

An example method may comprise generating, according to a first time constant, or first time resolution, a first amplitude measurement for a first frequency band of an audio signal, generating, according to a second time constant, or second time resolution, a second amplitude measurement for a second frequency band of the audio signal, determining a first amplitude ratio between the first amplitude measurement for the first frequency band of the audio signal and the second amplitude measurement for the second frequency band of the audio signal; and generating, based on the first amplitude ratio, a first vocal artifact (e.g., plosive) indication.

These as well as other novel advantages, details, examples, features and objects of the present disclosure will be apparent to those skilled in the art from following the detailed description, the attached claims and accompanying drawings, listed herein, which are useful in explaining the concepts discussed herein.

### BRIEF DESCRIPTION OF THE DRAWINGS

Some features are shown by way of example, and not by limitation, in the accompanying drawings. In the drawings, like numerals reference similar elements.

FIG. 1 illustrates an example network architecture that may be used to implement one or more illustrative aspects described herein.

FIG. 2 illustrates an example system architecture that may be used to implement one or more illustrative aspects described herein.

FIG. 3a illustrates a block diagram of an example vocal artifact attenuator that may be used to implement one or more illustrative aspects described herein.

FIG. 3b illustrates example subsystems of the vocal artifact attenuator of FIG. 3a.

FIG. 3c illustrates an example subsystem of the vocal artifact attenuator of FIG. 3a.

FIG. 4a illustrates an example flow chart of a method that may be performed to implement one or more illustrative aspects described herein.

FIG. 4b illustrates another example flow chart of a method that may be performed to implement one or more illustrative aspects described herein.

FIG. 4c illustrates another example flow chart of a method that may be performed to implement one or more illustrative aspects described herein.

FIG. 5a illustrates a block diagram of another example vocal artifact attenuator that may be used to implement one or more illustrative aspects described herein.

FIG. 5b illustrates a block diagram of another example vocal artifact attenuator that may be used to implement one or more illustrative aspects described herein.

FIG. 6 illustrates a block diagram of another example vocal artifact attenuator that may be used to implement one or more illustrative aspects described herein.

FIG. 7a illustrates an example audio waveform with an example vocal artifact attenuator in an active state.

FIG. 7b illustrates another example audio waveform with an example vocal artifact attenuator in an active state.

FIG. 8 illustrates another example vocal artifact attenuator that may be used to implement one or more illustrative aspects described herein.

### DETAILED DESCRIPTION

In the following description of the various examples, reference is made to the accompanying drawings, which form a part hereof, and in which is shown by way of illustration various examples in which aspects may be practiced. References to “embodiment,” “example,” and the like indicate that the embodiment(s) or example(s) of the invention so described may include particular features, structures, or characteristics, but not every embodiment or example necessarily includes the particular features, structures, or characteristics. Further, it is contemplated that certain embodiments or examples may have some, all, or none of the features described for other examples. And it is to be understood that other embodiments and examples may be utilized and structural and functional modifications may be made without departing from the scope of the present disclosure.

Unless otherwise specified, the use of the serial adjectives, such as, “first,” “second,” “third,” and the like that are used to describe components, are used only to indicate different components, which can be similar components. But the use of such serial adjectives is not intended to imply that the components must be provided in given order, either temporally, spatially, in ranking, or in any other way.

Also, while the terms “front,” “back,” “side,” and the like may be used in this specification to describe various example features and elements, these terms are used herein as a matter of convenience, for example, based on the example orientations shown in the figures and/or the orientations in typical use. Nothing in this specification should be construed as requiring a specific three dimensional or spatial orientation of structures in order to fall within the scope of the claims.

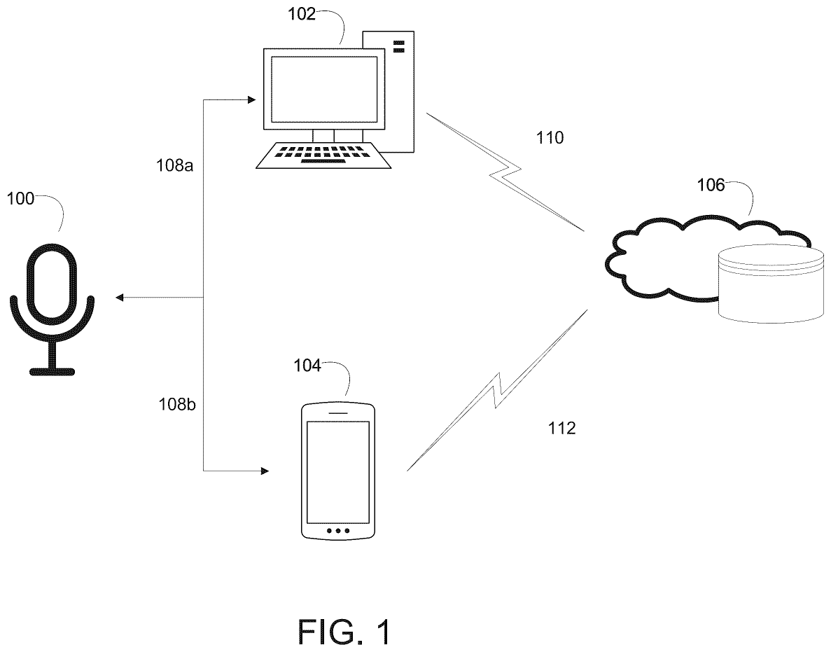

FIG. 1 illustrates an example of a network architecture that may be used to implement one or more illustrative aspects described herein in a standalone and/or networked environment. Device 100 may be a microphone, including any number of microphone types, such as a condenser microphone (e.g., including large- and small-diaphragm and electret condenser), a dynamic microphone (e.g., including moving coil and ribbon microphones), or a MEMS microphone, among others. Device 100 may be a smartphone microphone (such as that of smartphone 104), a desktop or laptop microphone (such as that of desktop 102), a headset microphone, a two-way radio microphone, or any other microphone that may be connected to and/or in communication with a device (such as devices 102 and 104). Device 100 may be a component of a wireless microphone system, such as, for example, a wireless transmitter, a wireless receiver, or a wireless transceiver. Device 100 may be any number of audio interfaces. Any one or more of devices 100, 102, 104, and 106 may be any type of known computer or server. Device 102 may be a desktop computer. Device 104 may be a smartphone or tablet. Devices 102 and 104 may include a user interface, including a graphical user interface, to allow a user to interact with the system. Device 106 may be a data server, including a cloud-based data server. Devices 100, 102, 104, and 106 may be interconnected via wide area network (WAN), such as the Internet. Other networks may also or alternatively be used, including local area networks (LAN), wireless networks, personal networks (PAN), and the like. Devices 100, 102, 104, and 106 and other devices (not shown) may or might not be communicatively connected to one or more of the networks via twisted pair wires, coaxial cable, fiber optics, radio waves, or other communication media. Device 100 may be communicatively connected to device 102 and/or device 104 via connections 108a and/or 108b, respectively. Device 102 may be communicatively connected to device 106 via connection 110 and device 104 may be communicatively connected to device 106 via connection 112.

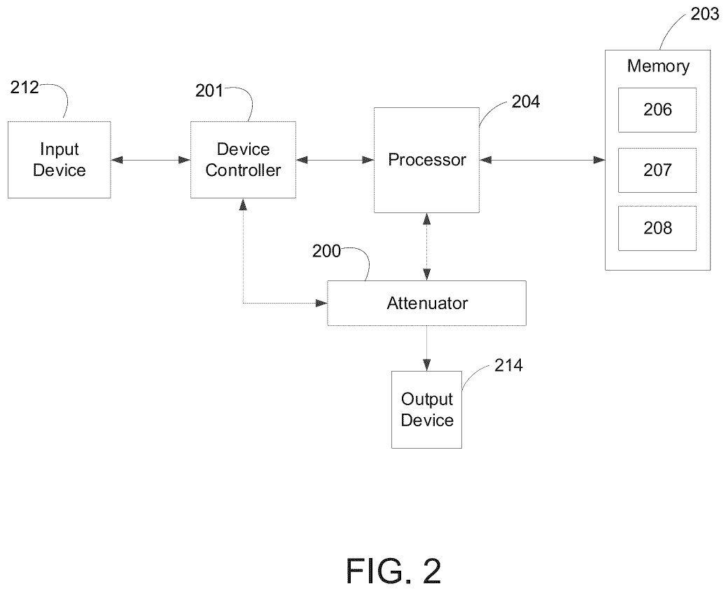

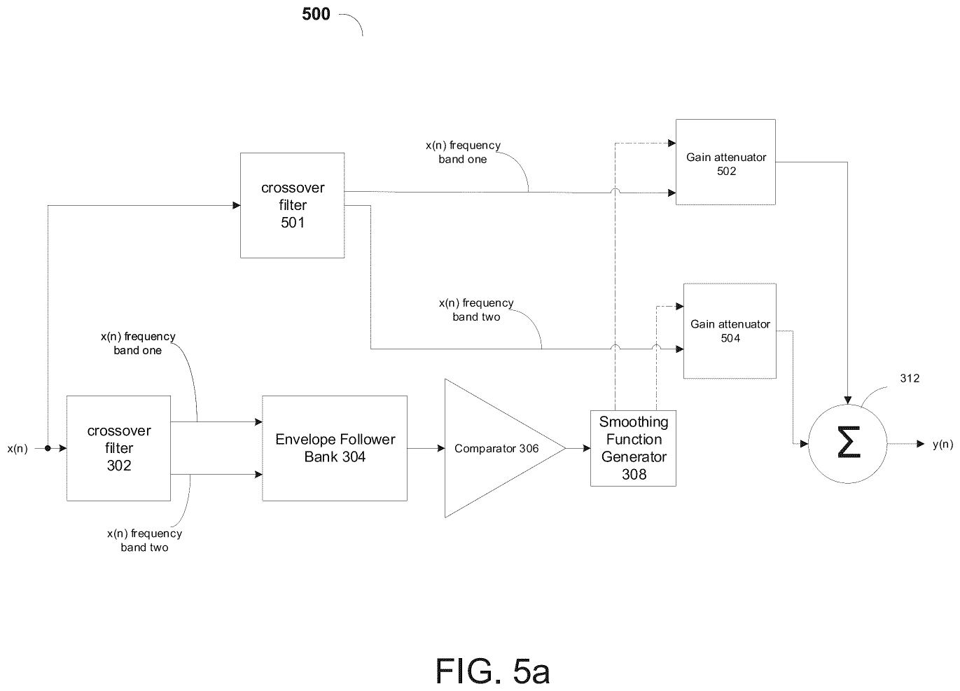

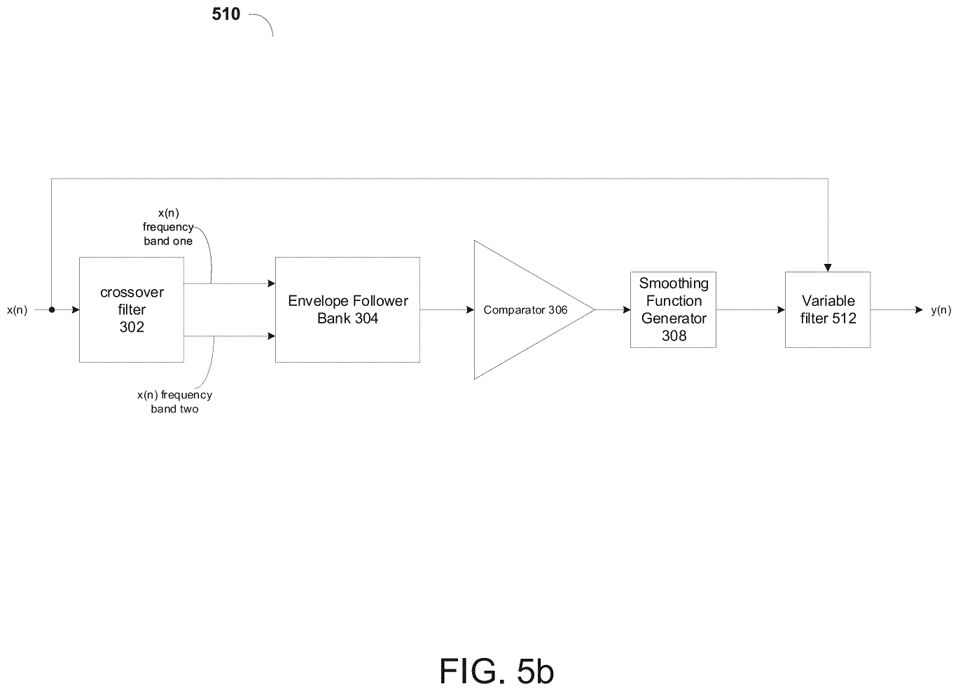

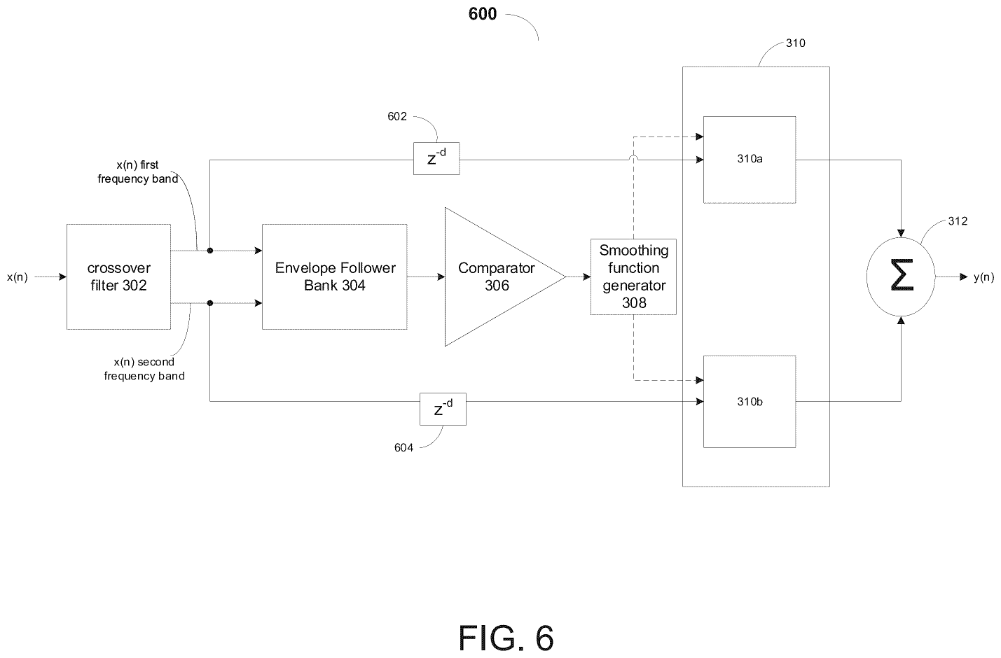

FIG. 2 illustrates an example of a system architecture that may be used to implement one or more illustrative aspects described herein. One or more of vocal artifact (e.g., plosive) attenuators 200, 500, 510 and/or 600 (hereinafter collectively referred to as “vocal artifact attenuators”) (vocal artifact attenuators 500, 510, and 600 described in greater detail with respect to FIGS. 5a, 5b, and 6, respectively) may be implemented as processor 204. Individual reference to vocal artifact attenuator 200, 500, 510, and/or 600 may also apply to the vocal artifact attenuator(s) not explicitly referenced. For the sake of simplicity, and except where otherwise noted, reference to vocal artifact attenuator 200 shall include vocal artifact attenuators 500, 510, and 600, and vice versa.

Processor 204 may be communicatively connected to memory 203. The memory 203 may store operating system software 206 for controlling overall operation of the vocal artifact attenuators and/or control logic 207 for instructing the vocal artifact attenuators to perform aspects described herein. Functionality of the control logic 207 may refer to operations or decisions made automatically based on rules coded into the control logic 207, made manually by a user providing input into the system, and/or a combination of automatic processing based on user input (e.g., queries, data updates, user-selected modes, a list of input devices previously setup with the software application, etc.). Memory 203 may store data used in performance of one or more aspects described herein, including at least one database 208. Memory may also store other data. For example, where the memory 203 is part of, for example, the input device 212, such as device 100, the memory may store its operating system and/or the software application that performs aspects described herein, user preferences such as preferred modes, a list of input devices (such as device 100, among others) previously setup with the software application, communication protocol settings, and/or data supporting any other functionality of the input device 212.

One or more aspects may be embodied in computer-usable or readable data and/or computer-executable instructions, such as in one or more program modules, executed by one or more computers or other devices as described herein, such as processor 204. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) Python, Perl, PHP, Ruby, JavaScript, and the like. The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, some or all of the functionalities performed by vocal artifact attenuators 200, 500, 510, and/or 600 may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

With further reference to FIGS. 1 and 2, one or more of the vocal artifact attenuators may be embodied in any one or more of devices 100, 102, 104, and/or 106, as well as (or alternatively) in one or more additional devices (not shown). One or more of the vocal artifact attenuators, device controller 201, memory 203, processor 204, and/or input device 212 may be embodied in any one or more of devices 100, 102, 104, and/or 106, as well as (or alternatively) in one or more additional devices (not shown). Aspects described herein may be operational with numerous other general purpose and/or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, supercomputers configured to run online application programming interfaces (APIs), distributed computing environments that include any of the above systems or devices, and the like. The vocal artifact attenuators may be implemented as embedded software running in, for example, device 100, and executable on processor 204. The vocal artifact attenuators may be implemented as an external signal processor, such as a hardware DSP module, a real-time software processor, an offline software processor, or a software plug-in (including VST, AU, and AAX formats). The vocal artifact attenuators may include several states, including an always-active state and an on/off state based on a user's input. In the always-active state, the vocal artifact attenuators may be implemented as a VST plugin. The VST may be inserted into a digital audio workstation (“DAW”) to actively monitor an incoming audio signal for vocal artifact events and detect and attenuate the vocal artifact events in real-time. One or more of the vocal artifact attenuators may be implemented as software or a plugin compatible with any number of video communications or video streaming platforms.

As shown in FIG. 2, input device 212 (such as device 100) may be in communication with device controller 201. Device controller 201 may facilitate interaction from input device 212 to one or more of the vocal artifact attenuators. Analog and/or digital audio may be transmitted from input device 212 to device controller 201. Digital data may be transmitted bidirectionally (from input device 212 to device controller 201, and/or from device controller 201 to input device 212). Input device 212 may include, for example, one or more universal serial bus (USB) connectors, one or more XLR connectors, one or more power connectors, and/or any other type of data and/or power connectors suitable for transporting signals such as power, digital data (including digital audio signals), and/or analog audio signals to and from input device 212. Where the connection is wired, device controller 201 may further comprise a data interface (not shown) for communicating with input device 212. For example, the data interface may comprise a USB interface or an XLR interface. While several wired connections are discussed between device controller 201 and input device 212, other types of wired or wireless connections may be used. For example, the connection between device controller 201 and input device 212 may instead be a wireless connection, such as a Wi-Fi connection or other proprietary wireless connection protocols, a Bluetooth connection, a near-field connection (NFC), and/or an infrared connection. Where the connection is wireless, device controller 201 and input device 212 may include a wireless communications interface.

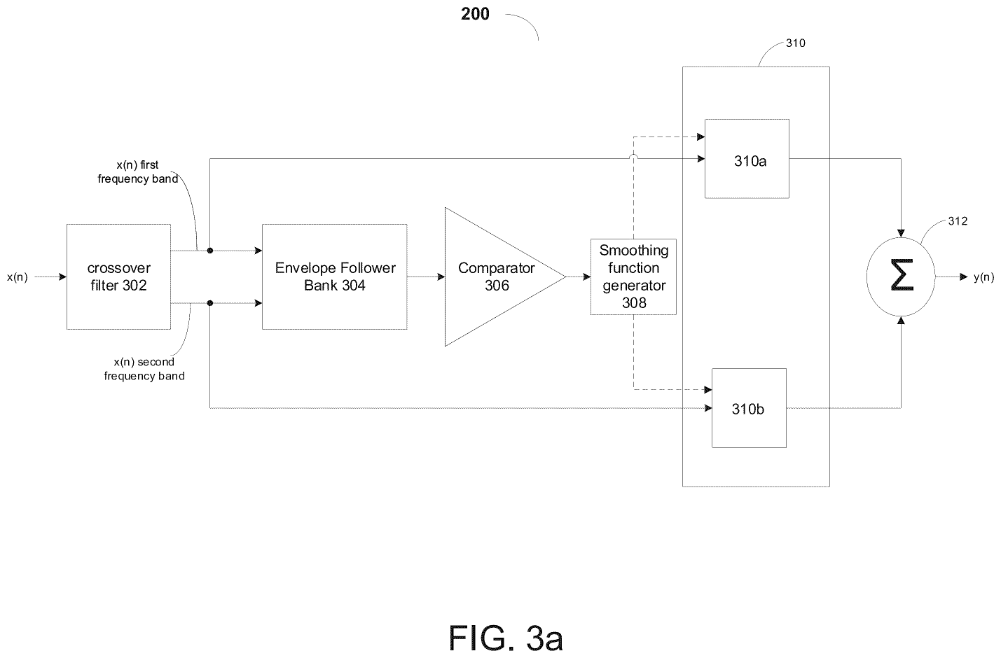

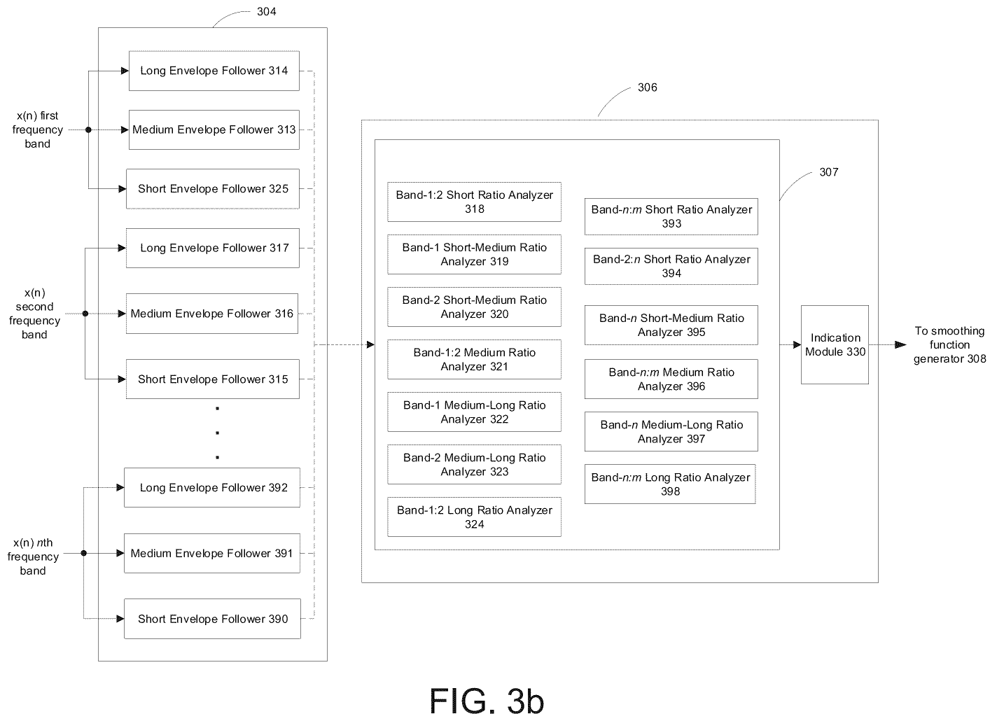

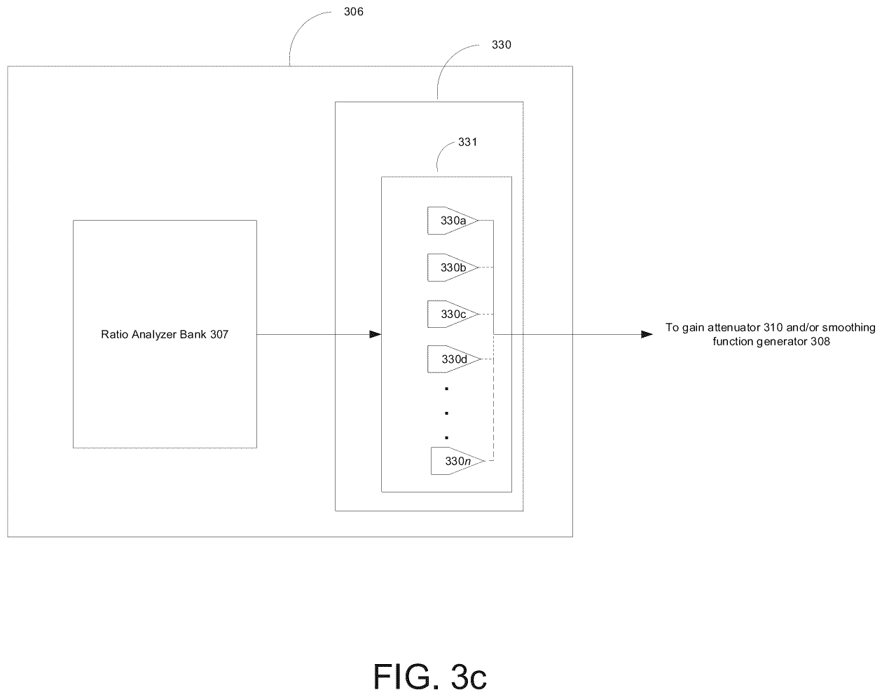

As shown in FIG. 3a, vocal artifact attenuator 200 may include crossover filter 302. Crossover filter 302 may be configured to receive an audio signal x(n) and to split signal x(n) into a first frequency band and a second frequency band. Crossover filter 302 may be configured to receive an audio signal x(n) and to split signal x(n) into two or more frequency bands. Crossover filter 302 may be any number of types of filters, including, but not limited to, minimum phase, linear phase, feed-forward, feed-back, etc. Crossover filter 302 may have a crossover frequency between 50 and 500 Hz. Crossover filter 302 may have a crossover frequency between more or less than 50 Hz (e.g., 1 Hz, 20 Hz, 60 Hz) and more or less than 1000 Hz (e.g., 600 Hz, 750 Hz, 1500 Hz, the highest-supported frequency of the system, etc.).

Vocal artifact attenuator 200 may include an envelope follower bank 304. Crossover filter 302 may provide a first frequency band and a second frequency band of signal x(n) to envelope follower bank 304. Envelope follower bank 304 may analyze the amplitudes, or envelopes, of the first and second frequency bands of signal x(n) according to one or more time constants, or time resolutions, such that short-, medium, and/or long-term properties of the first and/or second frequency bands may be measured. Envelope follower bank 304 may be configured to analyze two or more frequency bands based on the configuration of crossover filter 302. For example, envelope follower bank 304 may be configured to perform a three-band analysis of signal x(n).

Envelope follower bank 304 may generate one or more amplitude measurements of the first and/or second frequency bands. Envelope follower bank 304 may convert the amplitude measurements to a value, for example, comparable to decibels (dB), decibels relative to full scale (dBFS), decibel Volt (dBV), or sound pressure level (dB SPL), and may output one or more values to comparator 306. The output of the envelope follower bank 304 may be linear or logarithmic.

Vocal artifact attenuator 200 may include comparator 306. Comparator 306 may be configured to receive one or more amplitude measurements from envelope follower bank 304 and determine one or more differences between amplitude measurements, which may be generally referred to herein as amplitude ratios. Example of such ratios are described in further detail with respect to FIG. 3b and Tables 1 and 2 below. The comparator may utilize one or more of these amplitude ratios to determine if a vocal artifact event (e.g., plosive, sibilance, proximity effect) is occurring within a sample, or frame, of an audio signal.

Vocal artifact attenuator 200 may include a smoothing function generator 308 and gain attenuator module 310. Comparator 306 may indicate (or provide an output) to smoothing function generator 308 and/or gain attenuator 310 that a portion of the audio signal x(n) contains a plosive. Gain attenuator 310 may apply a gain attenuation to the first frequency band (via attenuator module 310a) and/or the second frequency band (via attenuator module 310b) for the duration of the plosive(s). Gain attenuator 310 may apply a gain attenuation to the first frequency band and/or the second frequency band according to a fixed (or static) attenuation value. Gain attenuator 310 may apply a gain attenuation to the first frequency band and/or the second frequency band according to a variable or adaptive attenuation value. Gain attenuator 310 may attenuate the first frequency band according to one fixed attenuation value and the second frequency band according to another fixed attenuation value. Gain attenuator 310 may comprise additional gain attenuator modules configured to apply a gain attenuation (according to a fixed, variable, or adaptive attenuation value) to any number of respective frequency bands.

Smoothing function generator 308 may be configured to provide one or more smoothing functions to the gain attenuator 310 to help minimize the presence of transient artifacts in the attenuated signal that may arise from abrupt changes in gain level. The output of the smoothing function generator may be a linear, exponential, or other non-linear curve between the current state of the gain attenuator and the desired level of attenuation as determined by the indication module 330 (described in greater detail with respect to FIGS. 3b and 3c). The smoothing function generated by smoothing function generator 308 may help the gain attenuator 310 transition between an “attenuate” state and an “un-attenuate” state. Gain attenuator 310 may transition between these states any number of times (i.e., for a fixed number of times or indefinitely).

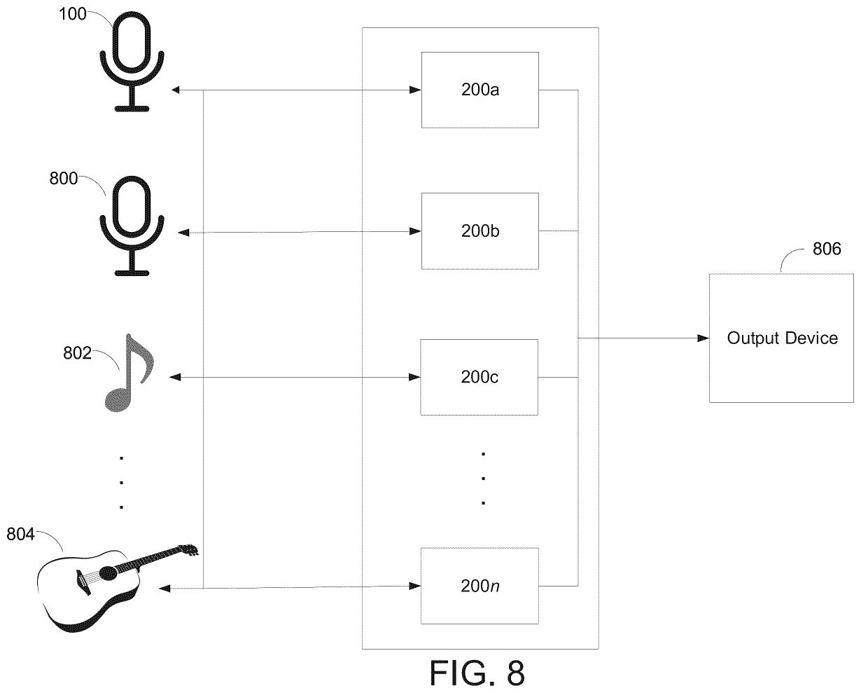

Vocal artifact attenuator 200 may include summing operator 312. Summing operator 312 may provide an output audio signal, such as output signal y(n). Output audio signal y(n) may comprise an attenuated frequency band and an unattenuated frequency band or two or more attenuated frequency bands. Summing operator 312 may receive an attenuated first frequency band of audio signal x(n) and an unattenuated second frequency band of audio signal x(n) and sum the frequency bands together to produce output audio signal y(n). Summing operator 312 may receive both an attenuated first frequency band of audio signal x(n) and an attenuated second frequency band of audio signal x(n) and may sum the frequency bands together to produce output audio signal y(n). Summing operator 312 may receive any number of combinations of attenuated and unattenuated frequency bands. An audio output device, such as output device 806 (discussed in greater detail with respect to FIG. 8), may receive output signal y(n) for further processing or for playback.

FIG. 3b illustrates an example block diagram of one or more portions of vocal artifact attenuator 200, including details of at least a portion of envelope follower bank 304 and comparator 306. Envelope follower bank 304 may include one or more envelope followers. Envelope follower bank 304 may include short envelope followers 315, 325, and 390; medium envelope followers 313, 316, and 391; and long envelope followers 314, 317, and 392 (collectively referred to hereinafter as “the envelope followers”). The envelope followers may operate according to any number and/or combination of methods of envelope followers, including single-pole averagers, moving averagers, frame-by-frame averagers, or peak-hold algorithms. The envelope followers may be configured with one or more time resolutions or time constants as the case may be. Each time constant may correspond to an attack time and a release time. The envelope followers may be configured with equivalent time constants that correspond to an equivalent attack time and release time. In an example, the envelope followers may be configured with time constants that are different, and, thus, correspond to different attack times and different release times.

Vocal artifact attenuator 200 may include frame-by-frame averagers (not shown) configured to perform frame-by-frame amplitude detection of an audio signal, such as signal x(n). One or more frame averagers may be configured to capture a root mean square (RMS), peak, and/or other measure of a frame of the audio signal. The frame may be any size, or duration. Frame-by-frame averagers may employ any number of measuring algorithms, such as linear-scaled algorithms, logarithmic-scaled algorithms, and/or algorithms formatted with other scaling. The frame-by-frame averagers may output to comparator 306. Comparator 306 may utilize one or more of these measurements to determine if a vocal artifact event is occurring according to aspects described herein.

Short envelope followers 315, 325, and 390 may be configured according to the same or different time constants that correspond to the same or different attack times and/or the same or different release times. Medium envelope followers 313, 316, and 391 may be configured according to the same or different time constants that correspond to the same or different attack times and/or the same or different release times. Long envelope followers 314, 317, and 392 may be configured according to the same or different time constants that correspond to the same or different attack times and/or the same or different release times. The envelope followers may be configured with time constants that correspond to an attack time of any duration, such as 0.1, 1, 10, 100, or 1,000 milliseconds (ms) (or any other value). The envelope followers may be configured with time constants that correspond to a release time of 0.1, 1, 10, 100, 1,000, or 5,000 ms (or any other value). A time constant may correspond to an attack time that is less than, equal to, or greater than a release time. For example, a time constant may correspond to an attack time of 0.1 ms and a release time of 10 ms; an attack time of 1.0 ms and a release time of 5,000 ms; etc.

One or more of the envelope followers may receive the first frequency band, the second frequency band, and/or up to the nth frequency band of signal x(n) from crossover filter 302 and may analyze the amplitudes, or envelopes, of one or all of these bands according to the aforementioned time constants and generate corresponding amplitude measurements. In an example, short envelope follower 325, medium envelop follower 313, and long envelope follower 314 may receive the first frequency band of signal x(n). Short envelope follower 325 may analyze the short-term properties of the first frequency band of signal x(n); medium envelope follower 313 may analyze the medium-term properties of the first frequency band of signal x(n); and long envelope follower 314 may analyze the long-term properties of the first frequency band of signal x(n). Short envelope follower 315, medium envelope follower 316, and long envelope follower 317 may receive the second frequency band of signal x(n) from crossover filter 302. Short envelope follower 315 may analyze the short-term properties of the second frequency band of signal x(n); medium envelope follower 316 may analyze the medium-term properties of the second frequency band of signal x(n); and long envelope follower 317 may analyze the long-term properties of the second frequency band of signal x(n). Envelope follower bank 304 may contain fewer or more envelope followers. The envelope followers may be arranged in any number of ways to receive the first, second, and/or nth frequency bands of signal x(n). The first, second, and nth frequency bands of signal x(n) may be routed in a number of different ways to the envelope followers.

With further reference to FIG. 3b, comparator 306 may include ratio analyzer bank 307. Ratio analyzer bank 307 may include a number of ratio analyzers, including band-1:2 short ratio analyzer 318, band-1 short-medium ratio analyzer 319, band-2 short-medium ratio analyzer 320, band-1:2 medium ratio analyzer 321, band-1 medium-long ratio analyzer 322, band-2 medium-long ratio analyzer 323, band-1:2 long ratio analyzer 324, band n:m short ratio analyzer 393, band-2:n short ratio analyzer 394, band-n short-medium ratio analyzer 395, band-n:m medium ratio analyzer 396, band-n medium-long ratio analyzer 397, and band-n:m long ratio analyzer 398 (collectively referred to hereinafter as “the ratio analyzers”). The ratio analyzers may be configured to receive one or more amplitude measurements generated by corresponding envelope followers. For example, band-1:2 short ratio analyzer 318 may receive an amplitude measurement from short envelope follower 315 and short envelope follower 325, and so on.

The ratio analyzers may receive one or more amplitude measurements, which may be represented as dB or dBFS, for example, from envelope follower bank 304. The ratio analyzers may compare the amplitude measurements of the envelope followers of the same time resolution between the first, second, and/or nth frequency band of signal x(n). The ratio analyzers may compare the amplitude measurements of the envelope followers of different time resolutions within the first, second, and/or nth frequency band of signal x(n).

The ratio analyzers may compare short-term properties (i.e., characteristics of signal x(n), such as low frequency energy and high frequency energy, that may be gleaned according to a time resolution that corresponds to an attack and release time of the shortest duration with respect to those of the medium-term and long term properties), medium-term properties (i.e., characteristics of signal x(n), such as low frequency energy and high frequency energy, that may be gleaned according to a time resolution that corresponds to an attack and release time of intermediate duration with respect to those of the short-term and long-term properties), and/or long-term properties (i.e., characteristics of signal x(n), such as low frequency energy and high frequency energy, that may be gleaned according to a time resolution that corresponds to an attack and release time of the longest duration with respect to those of the short-term and medium-term properties) of the first frequency band, the second frequency band, and/or the nth frequency band of signal x(n). The ratio analyzers may then each output a value, represented in dB, for example, that represents a difference between the values of the properties being analyzed.

As discussed above, the ratio analyzers may compare the amplitude measurements of the envelope followers of the same time resolution (i.e., the same attack and release times) between any combination of the first, second, and/or nth frequency band of signal x(n). The ratio analyzers may compare the amplitude measurements of the envelope followers of different time resolutions within any combination of the first, second, and/or nth frequency band of signal x(n).

For example, band-1:2 short ratio analyzer 318 may compare the short-term properties of the first frequency band of signal x(n) with the short-term properties of the second frequency band of signal x(n). Band-1:2 short ratio analyzer 318 may then output a value that represents, for example, the difference between the short-term properties of the first frequency band of signal x(n) and the short-term properties of the second frequency band of signal x(n) (i.e., a “short ratio”). Band-1:2 long ratio analyzer 324 may compare the long-term properties of the first frequency band of signal x(n) with the long-term properties of the second frequency band of signal x(n). Band-1:2 long ratio analyzer 324 may then output a value that represents, for example, the difference between the long-term properties of the first frequency band of signal x(n) and the long-term properties of the second frequency band of signal x(n) (i.e., a “long ratio”). Band-1 short-medium ratio analyzer 319 may compare the medium-term properties of the first frequency band of signal x(n) with the short-term properties of the first frequency band of signal x(n), and band-2 short-medium ratio analyzer 320 may compare the medium-term properties of the second frequency band of signal x(n) with the short-term properties of the second frequency band of signal x(n). Band-1 short-medium ratio analyzer 319 may output a value that represents, for example, the difference between the medium-term properties of the first frequency band of signal x(n) and the short-term properties of the first frequency band of signal x(n) (i.e., a “short-medium ratio”). Band-2 short-medium ratio analyzer 320 may output a value that represents, for example, the difference between the medium-term properties of the second frequency band of signal x(n) and the short-term properties of the second frequency band of signal x(n) (i.e., a “short-medium ratio”).

Comparator 306 may include an indication module 330. Indication module 330 may be configured to receive output values from the ratio analyzers and determine whether, based on one or more of the output values, a vocal artifact is present in the signal x(n). Indication module 330 may compare the previously mentioned “short ratios,” “long ratios,” and “short-medium ratios” to one or more thresholds. The thresholds may be fixed. The thresholds may be adjusted according to the “long ratio” value. Based on a comparison of one or more output values of the ratio analyzers to one or more thresholds, indication module 330 may determine: 1) whether a vocal artifact is occurring in the sample, or frame, of the audio signal; 2) whether to attenuate the first, second, and/or nth frequency band of signal x(n); and/or 3) the attenuation value to apply to the first, second, and/or nth frequency band of signal x(n).

Gain attenuator 310 may attenuate the first frequency band and/or the second frequency band according to a variable attenuation value. The variable attenuation value may be based on a ratio of the respective amplitudes of the first and second frequency bands, the first and nth frequency band, or the second and nth frequency band. For simplicity, a ratio between the first and second frequency bands will be discussed, but it is understood the foregoing also applies to ratios derived from nth and mth frequency bands. Comparator 306 may calculate a ratio between the amplitude of the first frequency band and the second frequency band. For example, band-1:2 short ratio analyzer 318, band-1:2 medium ratio analyzer 321, and/or band-1:2 long ratio analyzer 324 may derive the ratio between the amplitude of the first frequency band to that of the second frequency band and may output the value to indication module 330.

Indication module 330 may be configured to receive the ratio and may compare the ratio to one or more thresholds. The thresholds may be fixed or dynamic. If the ratio satisfies the one or more thresholds, indication module 330 may determine that a vocal artifact, such as, for example, unwanted sibilance, is present in signal x(n). Indication module 330 may determine to attenuate the first or second frequency band by, for example, a value that corresponds to the ratio of the amplitude of the first frequency band and the amplitude of the second frequency band. Stated differently, the amplitude ratio (e.g., represented as dB) between the first and second frequency bands may be the attenuation factor by which the first or second frequency band may be attenuated. Indication module 330 may output the variable attenuation value to smoothing function generator 308. Smoothing function generator 308 may output the variable attenuation value and/or any smoothing function(s) to gain attenuator 310. Smoothing function generator 308 may apply limits to the variable attenuation value to help minimize an unnatural timbre that may be attributed to high levels of attenuation. Gain attenuator 310 may attenuate the first and/or second frequency band according to the variable attenuation value.

As an example, in instances of unwanted sibilance, the high-band amplitude may be greater than that of the low-band. If the amplitude of the high-band is above that of the low band, it follows that the ratio of the respective amplitudes of the low-band to the high-band frequencies is less than 1. As discussed, if the ratio satisfies one or more criteria, or thresholds, gain attenuator 310 may attenuate the high-band frequency according to the variable attenuation value, based on the ratio between the amplitudes of the low- and high-frequency bands, which may help mitigate the unwanted sibilance.

With reference to FIG. 3c, indication module 330 may include an indication subsystem 331. Indication subsystem 331 may generate a number of vocal artifact indications 330a-330n based on any number or combinations of the previously described ratios. Vocal artifact indication 330a may be utilized by comparator 306 to determine whether an audio signal is present, or if the input signal is simply noise. Indication subsystem 331 may utilize a voice activity detector (not shown) to detect the presence or absence of user speech. Indication subsystem 331 may generate vocal artifact indication 330b which may be utilized by comparator 306 to determine whether the signal x(n) is high or low frequency dominant. Indication subsystem 331 may generate a vocal artifact indication 330c and/or 330d based upon a comparison of one or more ratios to one or more threshold values.

Comparator 306 may utilize any combination of vocal artifact indications 330a-330n to determine whether a vocal artifact is present in the signal x(n). Indication module 330 may provide an output which may indicate to gain attenuator 310 and/or smoothing function generator 308 whether attenuation should be applied to the first frequency band, the second frequency band, and/or the nth frequency band. Indication module 330 may provide an output indicating the attenuation value to be applied to the first frequency band, the second frequency band, and/or the nth frequency band. For example, the output of indication module 330 (or comparator 306) may comprise an indication that a vocal artifact is present in the audio signal (i.e., vocal artifact present signal). The output of indication module 330 may include an indication of which frequency band of audio signal x(n) to attenuate and/or the value by which to attenuate the first, second, and/or nth frequency bands. The output of indication module 330 may indicate the relative intensity of the plosive(s). Gain attenuator 310 may receive a vocal artifact present indication (i.e., an output) based on vocal artifact indication 330a and may attenuate the first frequency band, the second frequency band, and/or the nth frequency band of signal x(n) accordingly. Gain attenuator 310 may receive an output from comparator 306 based on any number or combination of vocal artifact indications 330a-330n and may attenuate the first, second, and/or nth frequency bands of signal x(n) accordingly. Comparator 306 may also provide an output (based on any number or combination of the vocal artifact indications 330a-330n) to smoothing function generator 308. Based on receiving an output from comparator 306, which may be based on one or more vocal artifact present signals 330a-330n, smoothing function generator 308 may provide any number of smoothing functions to the gain attenuator 310 to help minimize the presence of transient artifacts in the attenuated signal(s) that may arise from abrupt changes in gain level.

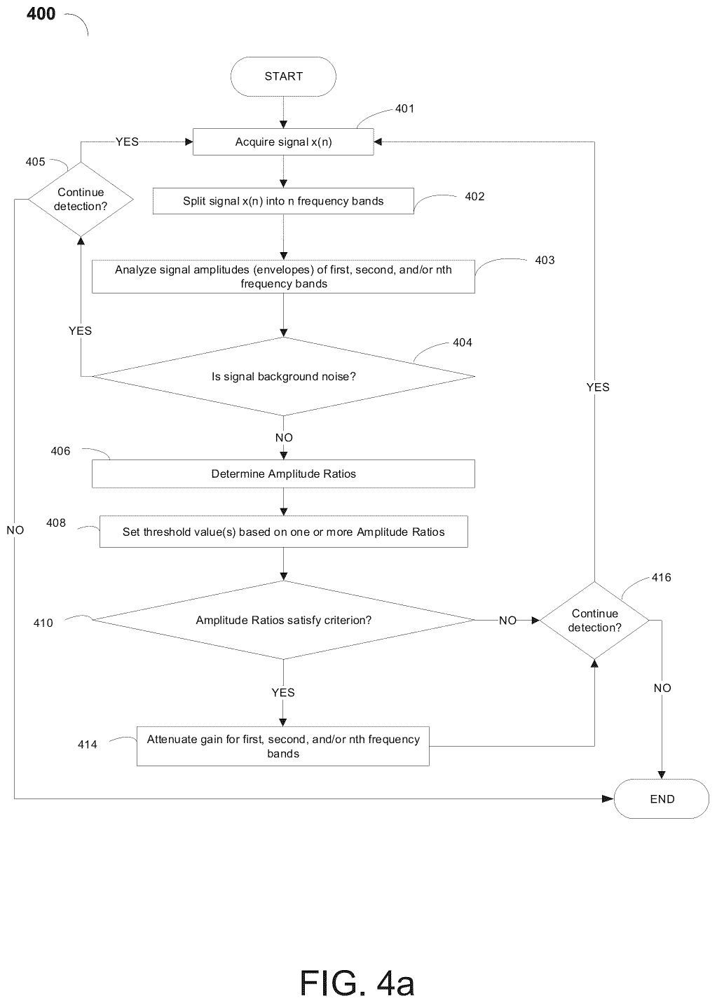

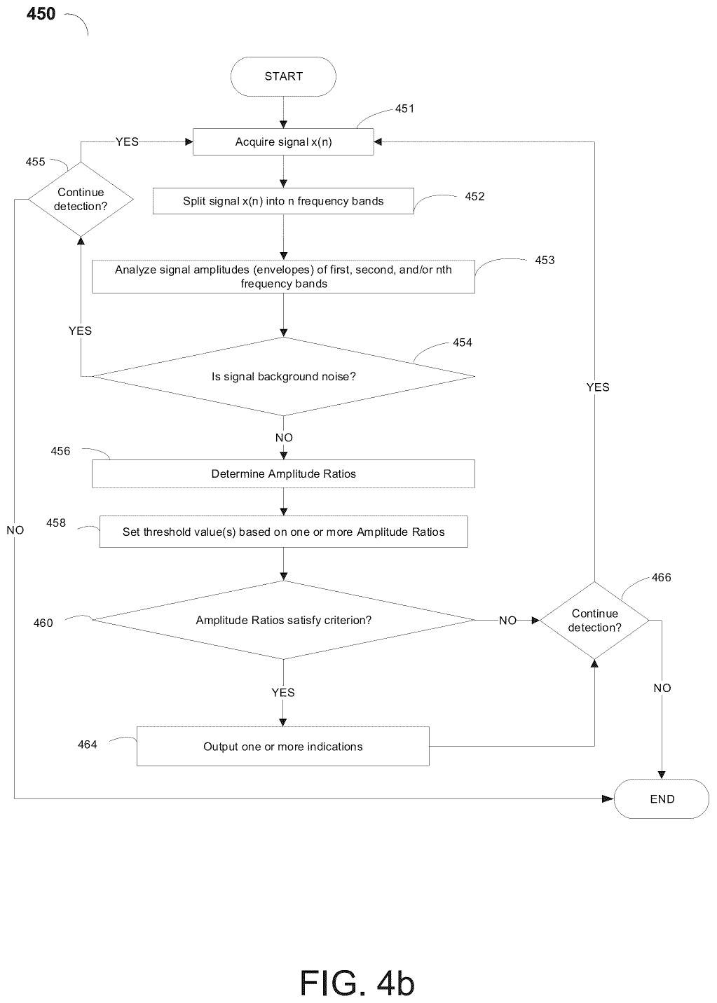

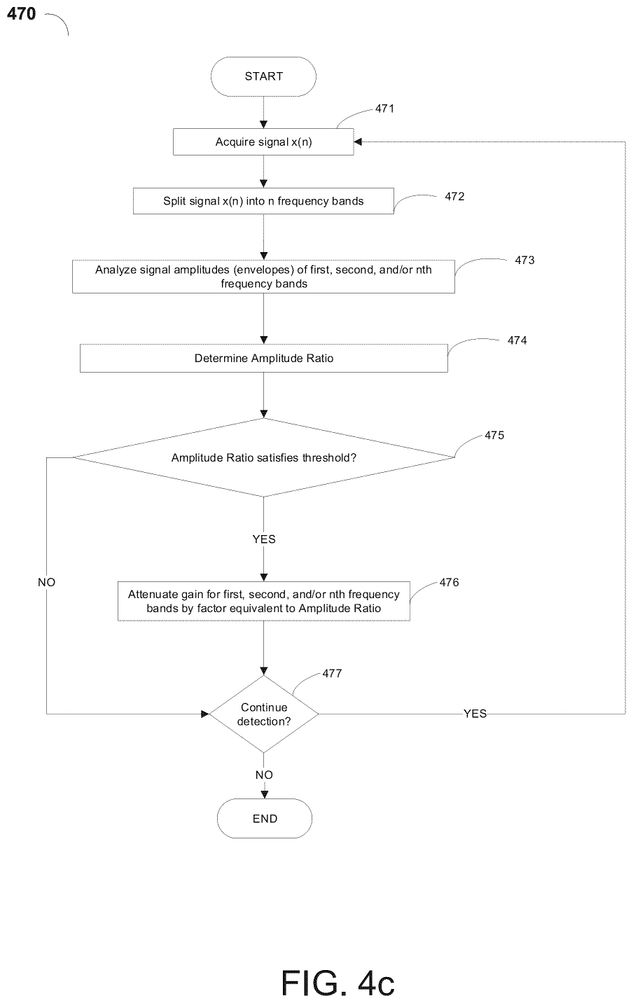

FIGS. 4a-4c illustrate example flow charts of respective methods that may be performed. Some or all of the steps of the flow charts illustrated in FIGS. 4a-4c may be performed by a vocal artifact attenuator housed in, for example, device 100, and some or all of the steps may be performed by a vocal artifact attenuator housed in a device connected to the device 100 (such as devices 102, 104, 106, and/or other devices operating a software application capable of performing the operations described herein). Some or all of the steps may be performed by firmware applications intended to run bare-metal without an operating system, such as, for example, one or more standalone microcontrollers, system-on-chip (SoC) integrated circuits, application specific integrated circuit (ASIC), or a digital signal processing (DSP) integrated circuit configured to perform the operations described herein natively, or performed by firmware or applications running under the control of an operating system executing on standalone microcontrollers, integrated microprocessors, system-on-chip (SoC) integrated circuits, or digital signal processing (DSP) integrated circuits. While the methods illustrated by FIGS. 4a-4c show particular steps in a particular order, the methods may be further subdivided into additional sub-steps, steps may be combined, the steps may be performed in other orders, and some steps may be omitted without necessarily deviating from the concepts described herein.

FIG. 4a illustrates an example flow chart of a method 400 that may be performed. In operation, crossover filter 302 may receive an audio signal x(n) from an input device, such as device 100, and split the audio signal x(n) into, for example, one, two, or n frequency bands (steps 401 and 402, FIG. 4). The audio signal may be generated by a user speaking into device 100, and/or playing an instrument into the microphone or line input of an input device. One or more of the envelope followers may analyze the amplitudes (or envelopes) of the first, second, and/or nth frequency bands of audio signal x(n) according to the concepts described herein (step 403).

Comparator 306 may determine whether the signal is simply background noise or is human speech or other appropriate sound (step 404). If the input signal x(n) is background noise (step 404: YES), vocal artifact attenuator 200 may continue to receive signal x(n) until an appropriate signal is detected. Vocal artifact attenuator 200 may operate continuously (step 405: YES), or may terminate after a number of iterations or upon user-initiated termination (step 405: NO). If the input signal x(n) contains appropriate characteristics (i.e., is human speech or instrument sound) (step 404: NO), the ratio analyzers may determine amplitude ratios in accordance with aspects described herein (step 406). Vocal artifact attenuator 200 may set a number of thresholds (e.g., short threshold, short-medium threshold) based on, for example, the long ratio value (step 408).

Indication module 330 may determine whether the amplitude ratios satisfy a variety of logical conditions as described herein, including, but not limited to, for example, whether the short ratio is less than a set short ratio threshold value or whether the short-medium ratio is less than a short-medium threshold value (step 410). If the amplitude ratios fail to satisfy one or more, or all, of the logical conditions (step 410: NO), vocal artifact attenuator 200 may automatically repeat, or continue, the vocal artifact detection (step 416: YES) for an indefinite number of iterations or for a set number of iterations. If the amplitude ratios satisfy one or more, or all, of the logical conditions (step 460: YES), comparator 306 may output one or more vocal artifact indications to gain attenuator 310.

Based on receiving an output from comparator 306 to 1) attenuate the first, second, and/or nth frequency bands of signal x(n) and/or 2) attenuate the first, second, and/or nth frequency bands of signal x(n) by a fixed or variable value, gain attenuator 310 may accordingly attenuate the gain of the first, second, and/or nth frequency band of signal x(n) according to aspects described herein (step 414). Vocal artifact attenuator 200 may receive instructions to automatically continue steps 401 through 414 (step 416: YES) for an indefinite number of iterations or to automatically continue steps 401 through 414 for a set number of iterations. In an example, vocal artifact attenuator 200 may receive instructions to terminate the procedure 400 (step 416: NO).

FIG. 4b illustrates an example flow chart of a method 450 that may be performed.

Steps 451-456, 458, 460, and 466 of FIG. 4b may be equivalent to steps 401-406, 408, 410, and 416, respectively, of method 400 (FIG. 4a). Indication module 330 may determine whether the amplitude ratios satisfy a variety of logical conditions as described herein (step 460). If the amplitude ratios fail to satisfy one or more, or all, of the logical conditions (step 460: NO), vocal artifact attenuator 200 may automatically repeat, or continue, the vocal artifact detection (step 466: YES) for an indefinite number of iterations or for a set number of iterations. If the amplitude ratios satisfy one or more, or all, of the logical conditions (step 460: YES), comparator 306 may output (or provide) one or more vocal artifact indications (step 464). Comparator 306 may provide one or more vocal artifact indications to any number of native or companion software, firmware, and/or hardware or hardware equivalents such as integrated circuits, field programmable gate arrays (FPGA), and the like. These native and/or companion software, firmware, and/or hardware or hardware equivalent elements may utilize one or more vocal artifact indications, for example, to detect plosives and/or to further process signal x(n).

FIG. 4c illustrates an example flow chart of a method 470 that may be performed. Steps 471-473 and 477 of FIG. 4c may be equivalent to steps 401-403 and 416, respectively, of method 400 (FIG. 4a). Comparator 306 may calculate a ratio between the amplitude of the first frequency band and the second frequency band (i.e., the Amplitude Ratio) (step 474). Indication module 330 may compare the ratio to one or more thresholds (step 475). If the ratio satisfies the one or more thresholds (step 475: YES), indication module 330 may determine that a vocal artifact, such as, for example, unwanted sibilance, is present in signal x(n). Gain attenuator 310 may attenuate the first and/or second frequency band according to the variable attenuation value (i.e., by a value equivalent to the Amplitude Ratio) (step 476). If the ratio does not satisfy one or more thresholds (step 475: NO), method 470 may proceed to step 477.

The preceding discussion may be further explained by way of example. Crossover filter 302 may split a sample of signal x(n) into first and second frequency bands in accordance with aspects described herein. The envelope followers may analyze the signal amplitudes (envelopes) of the first and second frequency bands of signal x(n) in accordance with aspects described herein. Comparator 306 may generate amplitude ratios and one or more outputs that may be based on one or more vocal artifact indications in accordance with aspects described herein. Table 1 below illustrates example values of converted amplitude measurements (in dBFS).

TABLE 1

| | Short | Short | Medium | Long | Long |
|---|---|---|---|---|---|
| | envelope | envelope | envelope | envelope | envelope |
| | follower 325 | follower 315 | follower 316 | follower 317 | follower 314 |
| Amplitude | −20 | −10 | −30 | −30 | −50 |
| measurement | | | | | |
| value (dBFS) | | | | | |

Table 2 below illustrates example amplitude ratios based on the example amplitude measurements in Table 1.

TABLE 2

| | Band-1:2 | Band-1:2 | Band-2 Short- |
|---|---|---|---|
| | Short Ratio | Long Ratio | Medium Ratio |
| Amplitude ratio | −10 | −20 | 20 |
| value (dB) | | | |

Table 3 illustrates example thresholds as discussed herein.

TABLE 3

| | Absolute | Short Ratio | Short-Medium | Long Ratio |
|---|---|---|---|---|
| | Threshold | Threshold | Ratio Threshold | Threshold |
| Value (dB) | −60 | −6 | −10 | 10 |

In this example, Band-1:2 Short Ratio may be calculated by subtracting the value of the measurement by the short envelope follower 315 from that of the short envelope follower 325. Band-1:2 Long Ratio may be calculated by subtracting the value of the measurement by the long envelope follower 317 from that of long envelope follower 314. Band-2 Short-Medium Ratio may be calculated by subtracting the value of the measurement by medium envelope follower 316 from that of short envelope follower 315.

In this example, the absolute threshold may be set to −60. In other examples, it may be set to greater than or less than −60. The value of the measurement of the first frequency band of signal x(n) by short envelope follower 325 may be compared to the absolute threshold to determine whether the signal contains appropriate characteristics or is simply background noise. Here, in this example, the value of the measurement of the first frequency band of signal x(n) by short envelope follower 325 is −20, which may indicate that the sample of signal x(n) contains human speech and not merely background noise.

One or more thresholds (e.g., the short threshold and/or the short-medium threshold) may be set based on the long ratio. The long ratio threshold may be set to 10. In other examples, it may be set to greater than or less than 10. The long ratio may dictate the value of the short threshold and/or the value of the short-medium threshold based on a comparison of the long ratio to the long ratio threshold. Indication subsystem 331 may generate vocal artifact indications 330b, 330c, 330d, and/or 330n based on a comparison of the short ratio to the short ratio threshold and/or a comparison of the short-medium ratio to the short-medium threshold.

Smoothing function generator 308 and gain attenuator 310 may receive an output from comparator 306 to attenuate the first, second, and/or nth frequency bands of signal x(n) and/or an indication from comparator 306 indicating the amount of gain attenuation to apply to the first, second, and/or nth frequency bands of signal x(n). The output may, in some examples, include or be based on some or all of vocal artifact indications 330a-330n. Gain attenuator 310 may attenuate the first, second, and/or nth frequency bands based on said output from comparator 306. As discussed above, the gain attenuator 310 may apply a gain attenuation to the first, second, and/or nth frequency bands according to a fixed (i.e., static), variable (or adaptive) attenuation value based on the output from comparator 306. The gain attenuator 310 may attenuate the first frequency band according to one fixed attenuation value, the second frequency band according to another fixed attenuation value, and the nth frequency band according to yet another fixed attenuation value. The gain attenuator 310 may attenuate the first, second, and/or nth frequency bands of signal x(n) by factors of 0.708 (−3 dB) to 0.001 (−60 dB). In at least some examples, the gain attenuator 310 may attenuate the first, second, and/or nth frequency bands of signal x(n) by factors of greater than 0.708 and/or less than 0.001.

User speech may have a wide variety of timbre, resonance, and pitch while the timbre and pitch of instrument sounds may vary according to instrument type. Some user speech may be low-frequency dominant while other user speech may be high-frequency dominant. As such, plosives that result from user speech may have low-frequency dominant and/or high-frequency dominant characteristics. FIG. 5a shows a block diagram of an example vocal artifact attenuator 500 that may be used to implement one or more illustrative aspects described herein. Vocal artifact attenuator 500 may be configured to attenuate a first frequency band, a second frequency band, and/or an nth frequency band of signal x(n). Vocal artifact attenuator 500 may include some or all of the same or equivalent elements as that of vocal artifact attenuator 200. Vocal artifact attenuator 500 may include crossover filter 501 and gain attenuators 502 and 504. Crossover filter 501 may be equivalent to crossover filter 302 described herein. Crossover filter 501 may be configured differently than crossover filter 302. Gain attenuator 502 may be configured to receive a first frequency band of signal x(n) from crossover filter 501 and a control signal from smoothing function generator 308 (indicated by dashed line) according to aspects described herein. Gain attenuator 504 may be configured to receive a second frequency band of signal x(n) from crossover filter 501 and a control signal from smoothing function generator 308 (indicated by dashed line) according to aspects described herein. Gain attenuator 502 and/or 504 may attenuate the first frequency band and/or the second frequency band according to a fixed and/or variable attenuation value according to aspects described herein.

Summing operator 312 may be configured to receive an attenuated first frequency band of audio signal x(n) and/or an attenuated second frequency band of audio signal x(n) and may sum the frequency bands together to produce output audio signal y(n). An audio output device, such as output device 806 (discussed in greater detail with respect to FIG. 8), may receive output signal y(n) for further processing or for playback.

FIG. 5b illustrates a block diagram of vocal artifact attenuator 510 that may be used to implement one or more illustrative aspects described herein. Vocal artifact attenuator 510 may include some or all of the same or equivalent elements as that of vocal artifact attenuators 200 and 500. Vocal artifact attenuator 510 may include a variable filter 512. Variable filter 512 may be configured to apply a static and/or variable gain attenuation to signal x(n) based on vocal artifact attenuator 510 detecting one or more vocal artifact events in audio signal x(n) according to aspects described herein.

Variable filter 512 may receive, from smoothing function generator 308, a control signal that may indicate, for example, an attenuation value that variable filter 512 may apply to one or more frequency ranges of audio signal x(n). The attenuation value may be fixed or variable. The variable attenuation value may be determined according to aspects described herein. For example, the ratio of the respective amplitudes of the first and second frequency bands may be utilized to adjust the attenuation value applied by variable filter 512.

The control signal may indicate, for example, an indication of a particular frequency range or a number of frequency ranges of signal x(n) to be attenuated. In operation, processor 204 may control the frequency response of variable filter 512. That is, based on a determination that one or more frequency ranges of signal x(n) should be attenuated, processor 204 may adjust the frequency response of variable filter 512 to attenuate the determined frequency range(s) of audio signal x(n).

Vocal artifact attenuators 200, 500, 510, and/or 600 may be utilized both in latency-critical applications, such as live performances, etc., and latency-tolerant applications, such as broadcast media, etc. For example, FIG. 6 shows a block diagram of vocal artifact attenuator 600 that may be used to implement one or more illustrative aspects described herein. Vocal artifact attenuator 600 may include delay 602 and delay 604. In operation, delays 602 and 604, as applied to the first, second, and/or nth frequency bands of signal x(n), may allow the action of the vocal artifact attenuator to better align to the vocal artifact event it is trying to mitigate. The detection of a vocal artifact event may require some duration of signal and might not be instantaneous. Delaying the audio signal in the gain attenuation path may allow the gain attenuation to begin at or before the beginning of the vocal artifact event.

Any of the circuitry in FIGS. 2, 3a, 3b, 3c, 5a, 5b, and 6 may be implemented as or incorporated into, for example, as a microcontroller, a programmable gate array (PGA), as a MOS integrated circuit (IC) chip, an ASIC, a DSP integrated circuit configured to perform the operations described herein natively or by the control of an operating system, a complex programmable logic device (CPLD), a field-programmable gate array (FPGA) chip, or an analog electrical circuit. The ASIC could contain a transistor, such as a FET. Any of the operations described herein may be implemented with hardware, software executable by, for example, processor 204, firmware, and/or a combination thereof.

The aspects described herein may be performed by a number of devices and/or device configurations. The aspects describe herein may be performed by device 100. No other equipment might be necessary to perform the operations described herein. A user may connect device 100 to devices 102, 104, 106, and/or other devices operating a software application capable of performing the operations described herein. Crossover filters 302 and 501, variable filter 512, envelope follower bank 304, comparator 306, smoothing function generator 308, gain attenuators 310, 502, and 504, delay 602 and delay 604, and summing operator 312 may be logical blocks implemented as embedded software running in, for example, device 100 and/or other devices operating a software application capable of performing operations described herein, and may be executable by processor 204. As described above, the aspects described herein may be performed by firmware applications intended to run bare-metal without an operating system such as, for example, one or more standalone microcontrollers, system-on-chip (SoC) integrated circuits, application specific integrated circuit (ASIC), or a digital signal processing (DSP) integrated circuit configured to perform the operations described herein natively, or performed by firmware or applications running under the control of an operating system executing on standalone microcontrollers, integrated microprocessors, system-on-chip (SoC) integrated circuits, or digital signal processing (DSP) integrated circuits. In an example, the aspects described herein can be performed by a smartphone, desktop computer, laptop computer, and/or other devices that may or might not have an internal microphone and/or a software application capable of performing the operations described herein. No other audio equipment might be necessary to perform the operations described herein.

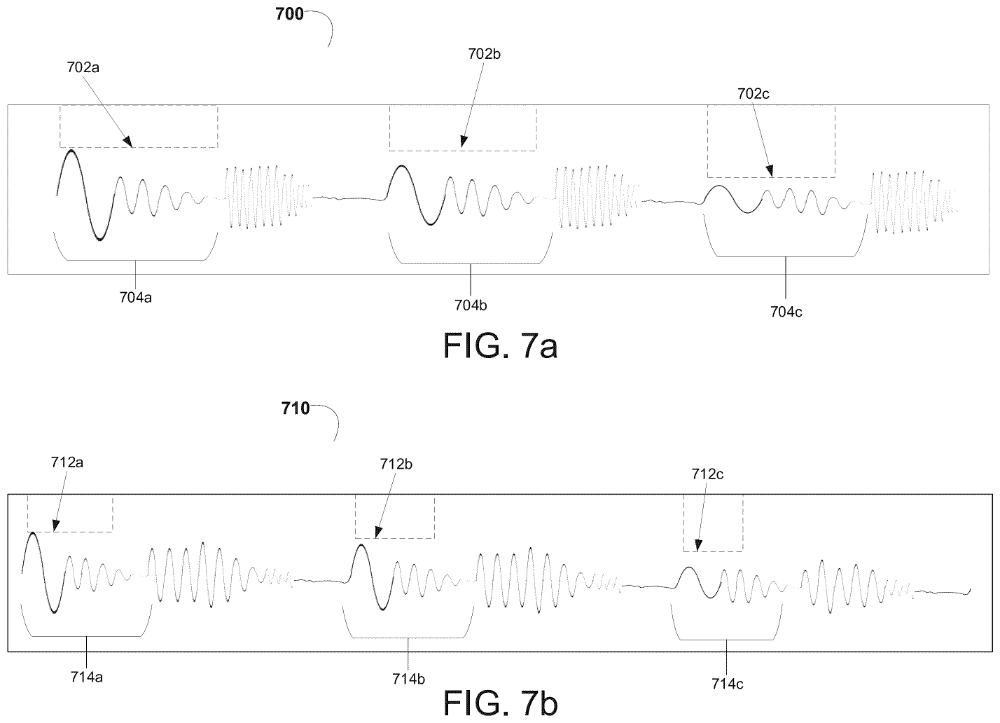

As has been discussed, user speech and instrument sounds, etc. may be low-frequency dominant or high-frequency dominant. Certain portions of user speech and instrument sounds may have low-frequency-dominant characteristics that can be mistaken as a plosive or other vocal artifact when in fact no vocal artifact is present in the audio signal. The vocal artifact attenuators may be configured to accurately detect and attenuate plosives and other artifacts for a wide range of user speech and instrument sounds while minimizing the occurrence of inappropriate attenuation (i.e., falsely detecting a plosive or artifact and applying attenuation when in fact no plosive or artifact is present in the audio signal). FIGS. 7a and 7b illustrate example waveforms of samples of user speech containing plosive artifacts. FIG. 7a illustrates an example waveform of a sample of user speech having speech characteristics that are not low-frequency dominant, while FIG. 7b illustrates an example waveform of user speech having low frequency-dominant characteristics. In each example, the vocal artifact attenuator may accurately detect each plosive event and discriminate each plosive event from the non-plosive audio, thus minimizing unnecessary attenuation of the audio signals.

In FIG. 7a, plosive events 704a, 704b, and 704c of waveform 700 depict plosive events throughout the waveform 700. Waveform 700 may represent, for example, audio signal x(n). Regions 702a, 702b, and 702c of waveform 700 depict attenuation of plosive events 704a, 704b, and 704c, respectively. Regions 702a, 702b, and 702c may correspond in duration to plosive events 704a, 704b, and 704c, respectively, such that when each plosive event ceases and normal speech (or sound) resumes, attenuation of the desired frequency band(s) of waveform 700 likewise terminates until, for example, the next plosive event occurs. Similarly, in FIG. 7b, which illustrates an example waveform of user speech having low frequency-dominant characteristics, plosive events 714a, 714b, and 714c of waveform 710 depict plosive events throughout waveform 710. Regions 712a, 712b, and 712c depict attenuation of plosive events 714a, 714b, and 714c, respectively. Regions 712a, 712b, and 712c may correspond in duration to plosive events 714a, 714b, and 714c, respectively, such that when each plosive event ceases and normal speech resumes, attenuation of the desired frequency band(s) of waveform 710 likewise terminates until, for example, the next plosive event occurs.

The vocal artifact attenuators may be compatible with any number and type of input devices, such as microphones, audio tracks, and/or instruments and may comprise any number of respective vocal artifact attenuator modules that correspond to each input device. FIG. 8 illustrates an example block diagram whereby one or more input devices 100, 800, 802, and 804 may be connected to vocal artifact attenuator modules 200a, 200b, 200c, and 200n, respectively. Vocal artifact attenuator modules 200a, 200b, 200c, and 200n may operate in accordance with concepts described herein. Vocal artifact attenuator modules 200a, 200b, 200c, and 200n may be any combination of vocal artifact attenuators 200, 500, 510, and 600. The input devices may include device 100, microphone 800, audio track 802, and/or musical instrument 804. Microphone 800 may include any number of microphone types, including a condenser microphone (including large- and small-diaphragm and electret condenser), a dynamic microphone (including moving coil and ribbon microphones), a MEMS microphone, etc. Audio track 802 may include a digital audio track (WAV, PCM, mp3, etc.), an analog audio track (e.g., the output of an audio mixer, etc.), or a line input. Musical instrument 804 may include a guitar, a keyboard, drums, or other musical instruments. The input devices may include more or fewer microphones, more or fewer audio tracks, and/or more or fewer musical instruments. The input devices may connect to the vocal artifact attenuators using any one of a variety of different connectors, including a LEMO connector, an XLR connector, a TQG connector, a TRS connector, a USB connector, or RCA connectors. The input devices may be wireless and connect to the vocal artifact attenuators through any one of a variety of protocols, including WiMAX, LTE, Bluetooth, Bluetooth Broadcast, GSM, 3G, 4G, 5G, Zigbee, 60 GHZ Wi-Fi, Wi-Fi (e.g., compatible with IEEE 802.11a/b/g/n/ac/ad/af/ah/ai/aj/aq/ax/ay/ba/bc), NFC protocols, proprietary wireless connection protocols, and/or any other protocol. Where the connection is wireless, the input devices (and/or their respective transmitters, receivers, or transceivers) and the vocal artifact attenuators may include a wireless communications interface. The vocal artifact attenuators may be compatible with any number and type of output devices, such as output device 806. Output device 806 may receive an output signal, such as signal y(n), from vocal artifact attenuator modules 200a-200n for playback, transmittal to another external device, or for further processing. Output device 806 may include, for example, loudspeakers or other audio output devices, an audio mixer, a wireless transmitter, receiver, transceiver, etc.

The vocal artifact attenuators may detect and alter a low frequency burst such as a bass drum, synthesized kick, or explosive according to the concepts described herein. Based on detecting a low frequency burst, the vocal artifact attenuators may apply gain attenuation to the input signal(s). The vocal artifact attenuators may apply additional signal processing, based on detecting a low frequency burst or other artifact, such as equalization, compression, de-essing, and the like, to the input signal(s) according to the concepts described herein. The vocal artifact attenuators may detect and attenuate mechanical artifacts such as collisions and finger tapping according to the methods described herein.

The concepts described herein may be performed with time domain signal processing methods and/or frequency domain signal processing methods. The ratio analyzers and indication module 330 may function similarly in the time domain as in the frequency domain. Gain attenuators 310, 502, and 504 may apply gain attenuation in the frequency domain. For example, the vocal artifact attenuators may utilize a short time Fourier transform (STFT), a discrete cosine transform (DCT), modified discrete cosine transform (MDCT), etc., to analyze the signal x(n) in time segments corresponding to the short time resolution described herein. One or more amplitude measurements of the first, second, and/or nth frequency bands of signal x(n) may be determined by summing the energy of the relevant frequency bins from each frame of the transform. Medium or long time resolutions may be determined by averaging the computed values from multiple consecutive transform frames (in the same frequency ranges, respectively). The gain attenuators may determine a desired frequency response to appropriately attenuate the signal, and may attenuate the audio signal x(n) accordingly. The vocal artifact attenuators might not apply filtering or attenuation in the time domain. The vocal artifact attenuators may apply gain attenuation by means of modifying the magnitudes of the relevant frequency bins. The vocal artifact attenuators may convert the attenuated signal x(n) back to the time domain for output or further processing.

A non-transitory machine-readable storage medium may comprise instructions, which, when executed by a processor, may cause the processor to: generate a first amplitude measurement for a first frequency band of an audio signal; generate a second amplitude measurement for a second frequency band of the audio signal; determine a first amplitude ratio between the first amplitude measurement for the first frequency band of the audio signal and the second amplitude measurement for the second frequency band of the audio signal; generate, based on the first amplitude ratio, a first vocal artifact indication; and attenuate at least one of the first frequency band of the audio signal or the second frequency band of the audio signal based on at least the first vocal artifact indication. The first amplitude measurement for the first frequency band of the audio signal may be generated according to a first time resolution and the second amplitude measurement for the second frequency band of the audio signal may be generated according to a second time resolution. The instructions may further cause the processor to attenuate, based on the first vocal artifact indication, at least one of the first frequency band of the audio signal or the second frequency band of the audio signal. An attenuation of the at least one of the first frequency band of the audio signal or the second frequency band of the audio signal may be based on a fixed attenuation value or a variable attenuation value. The variable attenuation value may be based on the first amplitude ratio. The first time resolution may be different from the second time resolution. The first frequency band may be different from the second frequency band. The instructions may further cause the processor to generate, according to a third time resolution, a third amplitude measurement for a first frequency band of the audio signal and a fourth amplitude measurement for a second frequency band of the audio signal; generate, according to a fourth time resolution, a fifth amplitude measurement for a second frequency band of an audio signal; determine a second amplitude ratio between the third amplitude measurement for the first frequency band of the audio signal and the fourth amplitude measurement for the second frequency band of the audio signal and a third amplitude ratio between the second amplitude measurement for the second frequency band of the audio signal and the fifth amplitude measurement for the second frequency band of the audio signal; generate, based on the second amplitude ratio, a second vocal artifact indication; and generate, based on the third amplitude ratio, a third vocal artifact indication.

An apparatus may comprise: a plurality of envelope followers which may comprise a first envelope follower configured with a first time resolution to generate, from an audio signal, a first amplitude measurement for a first frequency band of the audio signal and a second envelope follower configured with a second time resolution to generate, from the audio signal, a second amplitude measurement for a second frequency band of the audio signal; and a comparator configured to determine a first amplitude ratio between the first amplitude measurement for the first frequency band of the audio signal and the second amplitude measurement for the second frequency band of the audio signal, generate, based on the first amplitude ratio, a first vocal artifact indication. The apparatus may further comprise a gain attenuator configured to receive the first vocal artifact indication and attenuate, based on the first vocal artifact indication, at least one of the first frequency band of the audio signal or the second frequency band of the audio signal. The gain attenuator may be further configured to attenuate the first frequency band according to a first value and the second frequency band according to a second value. The first frequency band may be different from the second frequency band. The first time resolution may correspond to a first attack time and a first release time and the second time resolution may correspond to a second attack time and a second release time. The first attack time may be different from the second attack time and the first release time may be different from the second release time. The plurality of envelope followers may further comprise: a third envelope follower configured with a third time resolution to generate, from the audio signal, a third amplitude measurement for the first frequency band of the audio signal, and a fourth envelope follower configured with a fourth time resolution to generate, from the audio signal, a fourth amplitude measurement for the second frequency band of the audio signal; and a fifth envelope follower configured with a fifth time resolution to generate, from the audio signal, a fifth amplitude measurement for the second frequency band of the audio signal. The comparator may be further configured to receive the third amplitude measurement for the first frequency band of the audio signal, the fourth amplitude measurement for the second frequency band of the audio signal, and the fifth amplitude measurement for the second frequency band of the audio signal; determine a second amplitude ratio between the third amplitude measurement for the first frequency band of the audio signal and the fourth amplitude measurement for the second frequency band of the audio signal and a third amplitude ratio between the second amplitude measurement for the second frequency band of the audio signal and the fifth amplitude measurement for the second frequency band of the audio signal; generate, based on the second amplitude ratio, a second vocal artifact indication; and generate, based on the third sound level ratio, a third vocal artifact indication. The attenuation of the least one of the first frequency band of the audio signal or the second frequency band of the audio signal may be based on a fixed attenuation value or a variable attenuation value. The variable attenuation value is based on the first amplitude ratio. The apparatus may further comprise at least one of the group consisting of a wireless transmitter, a wireless transceiver, or a microphone.

A method may comprise: generating, according to a first time resolution, a first amplitude measurement for a first frequency band of an audio signal; generating, according to a second time resolution, a second amplitude measurement for a second frequency band of the audio signal; determining a first amplitude ratio between the first amplitude measurement for the first frequency band of the audio signal and the second amplitude measurement for the second frequency band of the audio signal; generating, based on the first amplitude ratio, a first vocal artifact indication; and attenuating, based on at least the first vocal artifact indication, at least one of the first frequency band of the audio signal or the second frequency band of the audio signal. The method may further comprise attenuating, based on the first vocal artifact indication, at least one of the first frequency band of the audio signal or the second frequency band of the audio signal. The attenuating may be further based on a fixed attenuation value or a variable attenuation value. The variable attenuation value may be based on the first amplitude ratio. The method may further comprise generating, according to a third time resolution, a third amplitude measurement for a first frequency band of the audio signal and a fourth amplitude measurement for a second frequency band of the audio signal; generating, according to a fourth time resolution, a fifth amplitude measurement for a second frequency band of an audio signal; determining a second amplitude ratio between the third amplitude measurement for the first frequency band of the audio signal and the fourth amplitude measurement for the second frequency band of the audio signal and a third amplitude ratio between the second amplitude measurement for the second frequency band of the audio signal and the fifth amplitude measurement for the second frequency band of the audio signal; generating, based on the second amplitude ratio, a second vocal artifact indication; and generating, based on the third amplitude ratio, a third vocal artifact indication. The first time resolution may be different from the second time resolution. The first frequency band may be different from the second frequency band.

In the foregoing specification, the present disclosure has been described with reference to specific exemplary examples thereof. Although the invention has been described in terms of a preferred example, those skilled in the art will recognize that various modifications, examples or variations of the invention can be practiced within the spirit and scope of the invention as set forth in the appended claims. The specification and drawings are, therefore, to be regarded in an illustrative rather than restrictive sense. Accordingly, it is not intended that the invention be limited except as may be necessary in view of the appended claims.

What is claimed is:

1. A non-transitory machine-readable storage medium comprising instructions which, when executed by a processor, cause the processor to:
generate a first amplitude measurement for a first frequency band of an audio signal;
generate a second amplitude measurement for a second frequency band of the audio signal;
determine a first amplitude ratio between the first amplitude measurement for the first frequency band of the audio signal and the second amplitude measurement for the second frequency band of the audio signal;
generate, based on the first amplitude ratio, a first vocal artifact indication; and
attenuate at least one of the first frequency band of the audio signal or the second frequency band of the audio signal based on at least the first vocal artifact indication.

2. The non-transitory machine-readable storage medium of claim 1, wherein the first amplitude measurement for the first frequency band of the audio signal is generated according to a first time resolution and wherein the second amplitude measurement for the second frequency band of the audio signal is generated according to a second time resolution.

3. The non-transitory machine-readable storage medium of claim 1, wherein an attenuation of the at least one of the first frequency band of the audio signal or the second frequency band of the audio signal is based on one of at least the group consisting of a fixed attenuation value or a variable attenuation value.

4. The non-transitory machine-readable storage medium of claim 3, wherein the variable attenuation value is based on the first amplitude ratio.

5. The non-transitory machine-readable storage medium of claim 1, wherein the instructions, when executed by the processor, further cause the processor to:
generate, according to a third time resolution, a third amplitude measurement for a first frequency band of the audio signal and a fourth amplitude measurement for a second frequency band of the audio signal;
generate, according to a fourth time resolution, a fifth amplitude measurement for a second frequency band of an audio signal;
determine:
a second amplitude ratio between the third amplitude measurement for the first frequency band of the audio signal and the fourth amplitude measurement for the second frequency band of the audio signal; and
a third amplitude ratio between the second amplitude measurement for the second frequency band of the audio signal and the fifth amplitude measurement for the second frequency band of the audio signal;
generate, based on the second amplitude ratio, a second vocal artifact indication;
generate, based on the third amplitude ratio, a third vocal artifact indication; and
attenuate, based on at least one of the group consisting of the first vocal artifact indication, the second vocal artifact indication, or the third vocal artifact indication, at least one of:
the first frequency band of the audio signal; or
the second frequency band of the audio signal.

6. An apparatus comprising:
a plurality of envelope followers, wherein the plurality of envelope followers comprises:
a first envelope follower configured to generate, from an audio signal, a first amplitude measurement for a first frequency band of the audio signal; and
a second envelope follower configured to generate, from the audio signal, a second amplitude measurement for a second frequency band of the audio signal;
a comparator configured to:
determine a first amplitude ratio between the first amplitude measurement for the first frequency band of the audio signal and the second amplitude measurement for the second frequency band of the audio signal; and
generate, based on the first amplitude ratio, a first vocal artifact indication; and
a gain attenuator configured to attenuate, based on the first vocal artifact indication, at least one of:
the first frequency band of the audio signal; or
the second frequency band of the audio signal.

7. The apparatus of claim 6, wherein the gain attenuator is further configured to attenuate:
the first frequency band according to a first value; and
the second frequency band according to a second value.

8. The apparatus of claim 6, wherein the first frequency band is different from the second frequency band.

9. The apparatus of claim 6, wherein:
the first envelope follower is configured with a first time resolution;
the second envelope follower is configured with a second time resolution;
the first time resolution corresponds to a first attack time and a first release time; and
the second time resolution corresponds to a second attack time and a second release time.

10. The apparatus of claim 9, wherein the first attack time is different from the second attack time, and the first release time is different from the second release time.

11. The apparatus of claim 6, wherein the plurality of envelope followers further comprises:
a third envelope follower configured with a third time resolution to generate, from the audio signal, a third amplitude measurement for the first frequency band of the audio signal;
a fourth envelope follower configured with a fourth time resolution to generate, from the audio signal, a fourth amplitude measurement for the second frequency band of the audio signal; and
a fifth envelope follower configured with a fifth time resolution to generate, from the audio signal, a fifth amplitude measurement for the second frequency band of the audio signal;
wherein the comparator is further configured to:
receive the third amplitude measurement for the first frequency band of the audio signal, the fourth amplitude measurement for the second frequency band of the audio signal, and the fifth amplitude measurement for the second frequency band of the audio signal;
determine:
a second amplitude ratio between the third amplitude measurement for the first frequency band of the audio signal and the fourth amplitude measurement for the second frequency band of the audio signal; and
a third amplitude ratio between the second amplitude measurement for the second frequency band of the audio signal and the fifth amplitude measurement for the second frequency band of the audio signal;
generate, based on the second amplitude ratio, a second vocal artifact indication;
generate, based on the third amplitude ratio, a third vocal artifact indication; and
attenuate, based on at least one of the group consisting of the first vocal artifact indication, the second vocal artifact indication, or the third indication, at least one of:
the first frequency band of the audio signal; or
the second frequency band of the audio signal.

12. The apparatus of claim 6, wherein an attenuation of the least one of the first frequency band of the audio signal or the second frequency band of the audio signal is based on one of at least the group consisting of a fixed attenuation value or a variable attenuation value.

13. The apparatus of claim 12, wherein the variable attenuation value is based on the first amplitude ratio.

14. The apparatus of claim 6, further comprising at least one of the group consisting of a wireless transmitter, a wireless receiver, a wireless transceiver, or a microphone.

15. A method comprising:
generating a first amplitude measurement for a first frequency band of an audio signal;
generating a second amplitude measurement for a second frequency band of the audio signal;
determining a first amplitude ratio between the first amplitude measurement for the first frequency band of the audio signal and the second amplitude measurement for the second frequency band of the audio signal;
generating, based on the first amplitude ratio, a first vocal artifact indication; and
attenuating, based on at least the first vocal artifact indication, at least one of:
the first frequency band of the audio signal; or
the second frequency band of the audio signal.

16. The method of claim 15, wherein the attenuating is further based on one of at least the group consisting of a fixed attenuation value or a variable attenuation value.

17. The method of claim 16, wherein the variable attenuation value is based on the first amplitude ratio.

18. The method of claim 15, wherein the first amplitude measurement for the first frequency band of an audio signal is generated according to a first time resolution and wherein the second amplitude measurement for the second frequency band of the audio signal is generated according to a second time resolution.

19. The method of claim 15, further comprising:
generating, according to a third time resolution, a third amplitude measurement for a first frequency band of the audio signal and a fourth amplitude measurement for a second frequency band of the audio signal;
generating, according to a fourth time resolution, a fifth amplitude measurement for a second frequency band of an audio signal; and
determining:
a second amplitude ratio between the third amplitude measurement for the first frequency band of the audio signal and the fourth amplitude measurement for the second frequency band of the audio signal; and
a third amplitude ratio between the second amplitude measurement for the second frequency band of the audio signal and the fifth amplitude measurement for the second frequency band of the audio signal.

20. The method of claim 19, further comprising:
generating, based on the second amplitude ratio, a second vocal artifact indication;
generating, based on the third amplitude ratio, a third vocal artifact indication; and
attenuating, based on at least the group consisting of the first vocal artifact indication, the second vocal artifact indication, or the third vocal artifact indication, at least one of:
the first frequency band of the audio signal; or
the second frequency band of the audio signal.
